(19) United States
(12) Patent Application Publication
(10) Pub. No.: US 2011/0078859 A1
(43) Pub. Date: Apr. 7, 2011

(54) Sleep Methods and Devices for Reducing Cardio-Pulmonary Risks Factors

(76) Inventor: Vaughn W. North, Salt Lake City, UT (US)

(21) Appl. No.: 12/898,556

(22) Filed: Oct. 5, 2010

Related U.S. Application Data
(60) Provisional application No. 61/248,710, filed on Oct. 5, 2009.

(51) Int. Cl. G06Q 50/00; A47C 20/00; G06Q 40/00; G06Q 30/00

(52) U.S. Cl. 5/632; 5/648; 705/4; 705/14.4; 705/3

(57) ABSTRACT

A method and device for reducing tendencies for occurrence of cardiovascular/pulmonary risk factors for a human body as part of a preventative health regimen comprising the steps of (a) positioning the body between opposing first and second pillows attached together by an intermediate member such that the body has concurrent opposing contact at forward and rearward orientations with respect to the two opposing pillows in tension, including contact of one pillow at a back portion of the body and contact of the second pillow with an extended arm or leg during natural sleep on a bed; (b) repeating a sequence of habitual side-sleeping positions of the body based on the forward and rearward contacts with the opposing pillows to establish a memory of the sequence and feelings associated with the contacts; and (c) applying this sequence during normal sleep to condition the body and mind to favor a side rather than supine sleeping orientation.

### CLAIM OF PRIORITY

This application claims priority to U.S. Provisional Application No. 61/248,710 filed on Oct. 5, 2009 which is incorporated herein by reference in its entirety.

### BACKGROUND OF THE INVENTION

1. Field of the Invention

The present invention relates generally to a method for reducing risk factors related to various forms of cardiovascular diseases such as hypertension, coronary artery disease, diabetes and pulmonary hypertension, and other adverse medical conditions that arise from prolonged sleep depravation and other forms of interference with deep sleep such as sleep apnea, snoring, emotional stress, etc. More particularly, the present invention relates to reducing the likelihood of occurrence of certain physical conditions (i.e. risk factors) that attend a medical condition known as sleep apnea (central and obstructional) which may lead to these types of cardiovascular/pulmonary diseases. The present invention also relates to methods and devices for reducing the occurrence of sleep interruption conditions such as sleep apnea and snoring by enabling a person to sleep on their side in preferential positions according to the individual's personal positional preferences, thereby relieving the body of physical and mental stresses that arise during that person's sleep activity.

2. Prior Art

Preventative measures for sustaining optimal health are receiving increasing attention throughout the world. In particular, communities, medical associations and governments are advancing research and educational efforts to identify and adopt healthy lifestyle practices that can reduce the probability of such conditions as cardiovascular and pulmonary diseases, cancer, and numerous other major categories of illness. Many of these efforts include recommendations that recognize the value of simple measures such as diet, exercise, healthy emotional state and avoidance of harmful substances. It has been long recognized that sufficient and proper sleep is another key factor in preserving the health of the human body. It has also been recognized that positioning the body in a side-sleeping rather than a supine orientation is beneficial to reduce the likelihood of snoring and sleep apnea, as well as risk factors associated with these conditions.

### SUMMARY OF THE INVENTION

The present invention provides a pillow system and method of use for preventing or reducing adverse physiological and mental stress that arises when the body is in an unhealthy position during sleep by enabling an individual to memorize or program and adopt certain preferential sleeping positions that are suited to that individual. By relieving the body of such stress during prolonged sleep, greater healing and restoration occurs. Specifically, by enabling a person to assume preferential, healthy sleeping positions, the individual also avoids or reduces the occurrence of adverse conditions such as stress, sleep apnea, snoring, and other attendant risk factors such as referenced above. Specifically, the present invention provides methods and devices preventing and/or minimizing occurrence of such risk factors by mechanically enabling the person to position the body in a variety of preferential side-sleeping positions and sustaining these positions on a habitual basis during sleep.

Specifically, a method and device are disclosed for reducing tendencies for occurrence of cardiovascular/pulmonary risk factors for a human body as part of a preventative health regimen. The method comprises the steps of:

a. positioning the body between opposing first and second pillows attached together by an intermediate member such that the body has concurrent opposing contact at forward and rearward orientations with respect to the two opposing pillows in tension, including contact of one pillow at a back portion of the body and contact of the second pillow with an extended arm or leg during natural sleep on a bed;

b. repeating a sequence of habitual side-sleeping positions of the body based on the forward and rearward contacts with the opposing pillows to establish a memory of the sequence and feelings associated with the contacts; and

c. applying this sequence during normal sleep to condition the body and mind to favor a side rather than supine sleeping orientation.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 illustrates a perspective view of the present invention showing opposing pillows tethered to an intermediate member.

FIG. 2 depicts a graphic, perspective view of the invention in use on a bed with the pillow system fully extended.

FIG. 3 shows an alternate sleeping position with the present invention with the system fully retracted to the user's body.

FIG. 4 demonstrates an additional sleeping position with the knee engaging the pillow extended the full length.

FIG. 5 depicts the pillow in partial extension, captured at the user's knees.

FIG. 6 illustrates the pillow partially extended, with the user's right leg draped over the pillow.

FIG. 7 shows the pillow in a retracted position against the user, with the right leg extended over the pillow and the left leg partially captured under the pillow.

FIG. 8 depicts a partially extended pillow configuration with the pillow captured between the user's knees.

FIG. 9 illustrates an alternate embodiment of the pillow system.

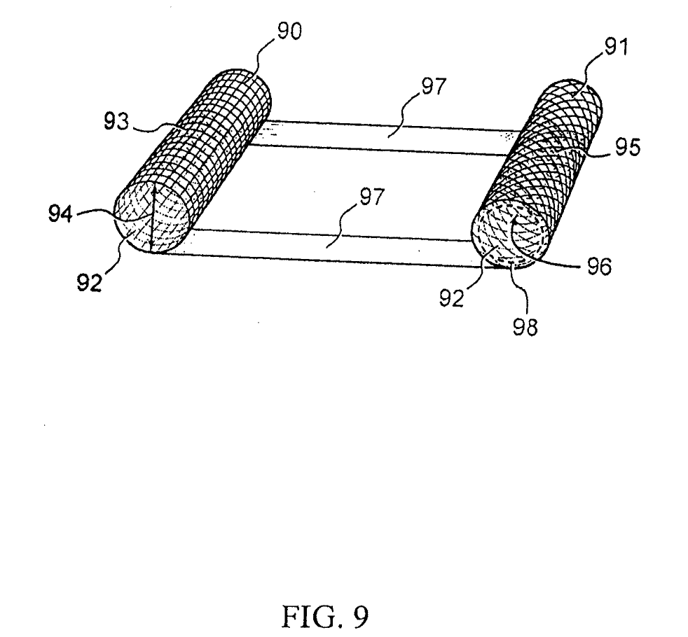

FIG. 10 shows a layout for one embodiment of the pillow system using bed sheet material.

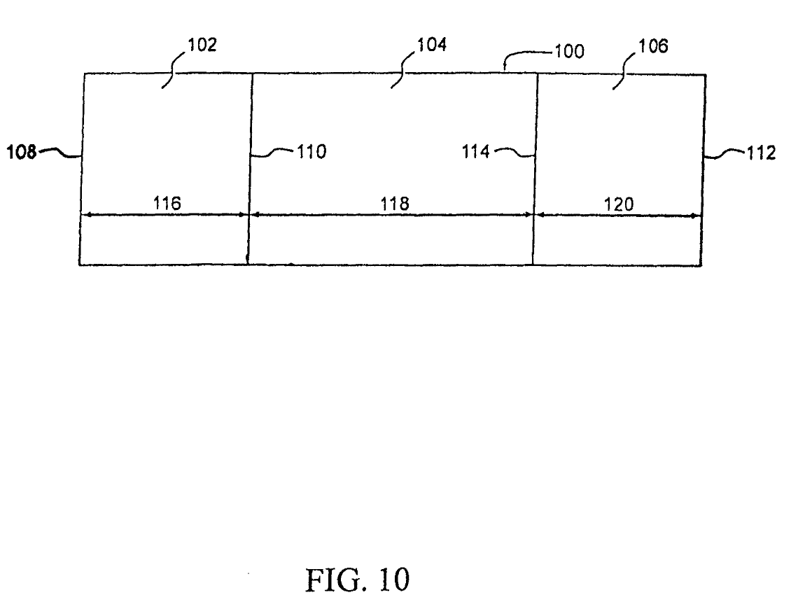

FIG. 11 depicts an additional embodiment of the pillow system with a removable pillow at one side.

FIG. 12 illustrates an additional embodiment of the pillow system adapted for use with a companion sleeper.

### DETAILED DESCRIPTION

The interrelationship of cardiovascular functions and sleep patterns has been well documented. For example, the occurrence of hypertension or high blood pressure is now considered a possible indicator and consequence of sleep apnea. Indeed, upon diagnosis of hypertension in a patient, some medical specialists are now recommending the administration of sleep study tests for apnea followed by related therapy as standard protocol (e.g. continuous positive airway pressure or CPAP during sleep). It is also well known that the effects of sleep apnea due to upper airway closure in the throat or pharyngeal region may be reduced by maintaining a side sleeping position as opposed to supine orientation.

A large percentage of the human population currently manifests various risk factors associated with sleep apnea (e.g. snoring), which may be linked to cardiovascular and/or pulmonary conditions. Many such conditions may exist in an indefinite or even indeterminable state, giving little warning to the individual of a future high risks posture. Typical lifestyle patterns may aggravate these conditions, such as lack of exercise, obesity, smoking, use of alcohol, etc. Accordingly, much of the population may be potentially at risk for sleep apnea and similar conditions; however, little motivation exists to address the potential problem because of lack of awareness or appreciation for the significance or presence of such risk factors. Medical tests are expensive and many health insurance programs will not cover preventive medicine. With the ever increasing level of stress associated with daily living in a fast paced society, such medical risks are most likely to increase well into the future.

The present invention proposes a preventative and therapeutic approach to management of an individual's sleep regimen utilizing sleep positioning to favorably influence the risk factors associated with OSA and other sleep stressing conditions that may lead to various cardiovascular and pulmonary diseases. Specifically, the function of the upper airway appears to respond differently during sleep, depending upon the body's orientation in a supine versus side sleeping position. Although detailed studies of these differences are not yet fully documented, the consequence of these opposing positions is clear. Persons sleeping on their side are likely to be more healthy.

For example, a person having sleep apnea may require CPAP therapy as part of a nightly sleep ritual. This involves application of positive pressure support by means of a small blower or air pump and an interface (e.g. nasal or oral and nasal mask) in order to maintain the upper airway or throat passage in an open position Most patients experience the highest level of sleep interruption or greatest number of sleep arousals due to respiratory disturbances when they sleep on their back or in the supine position. This occurs because the upper airway dilating or breathing musculature of the throat and tongue, are more vulnerable to collapse or weakness in a supine position.

Regardless of cause, medical studies have shown that by repositioning the body to a side sleeping orientation, an individual's risk of obstructive sleep apnea can be significantly reduced. It would appear, therefore, that a supine position will favor a patho-physiologic state that is more conducive to developing sleep apnea than when sleeping on one's side. Such a relationship between the breathing anatomy and sleep is further indicated by similar experience with the phenomenon of snoring, a common symptom and risk factor for OSA. Many persons that suffer from snoring when in the supine position can significantly reduce this problem by sleeping on their sides. Therefore, there appears to be a clear advantage associating uninterrupted respiration and sleep by maintaining a non-supine position during sleep.

The present invention proposes a preventative as well as a potential adjunctive therapeutic approach to diminish the risk factor issues of cardiovascular and pulmonary degeneration, particularly those that may be associated with the aging process, by encouraging individuals to adopt a sleep protocol which avoids supine orientation where possible. Although some physical conditions may require a supine orientation, most individuals are free to randomly choose their sleeping position. In view of the current state of the art, most individuals are unaware and pay little attention to the importance of their regular sleep positions as they may relate to cardiovascular and pulmonary health. To the contrary, however, the present invention suggests that by consciously implementing measures to condition their mind and behavior to a side sleeping preference, some benefits of preventative health could be achieved.

Specifically, the same musculature that appears to adapt or degenerate with age or other adverse physiological change, particularly when accompanied by obesity and other aging factors, could be favorably influenced by avoiding habitual supine sleep orientation. Such preventative action may actually reduce the likelihood or severity of sleep apnea, as well as snoring and related breathing issues. Whether this could also impact occurrence of hypertension and other common cardiovascular conditions is presently being considered as part of this invention; however, the simplicity of adopting a preferential attitude for sleeping on one's side would seem to be a reasonable basis for modifying one's behavior at or before the onset of any risk factor such as hypertension.

Accordingly, the broad concept of the present invention is to provide mechanical devices and methods for individual use that encourage and enable conditioning the body to favor a side sleeping orientation as part of a preventive health approach for cardio/pulmonary issues. A parent patent application entitled A Device and Method for Maintaining a Side Sleeping Position filed Jun. 24, 2009 (U.S. application Ser. No. 12/490,143) by the present inventor discloses a principle referred to as positional sleep orientation aspect (POSA) that can facilitate the conditioning of the human body in this manner. Various devices are disclosed to enable an individual to manage their sleep orientation even in a subconscious state to remain on their side. This application is incorporated herein by reference and should be considered as part of the enabling disclosure to teach the background and mechanics of the present invention.

The referenced patent application teaches that the body can be trained to be aware of its side-sleeping orientation, even when in a subconscious state as during sleep. This is accomplished by establishing at least three points of contact in a three dimensional frame of reference. This three point frame of reference allows the body to maintain and awareness of body position, even during subconscious states of sleep.

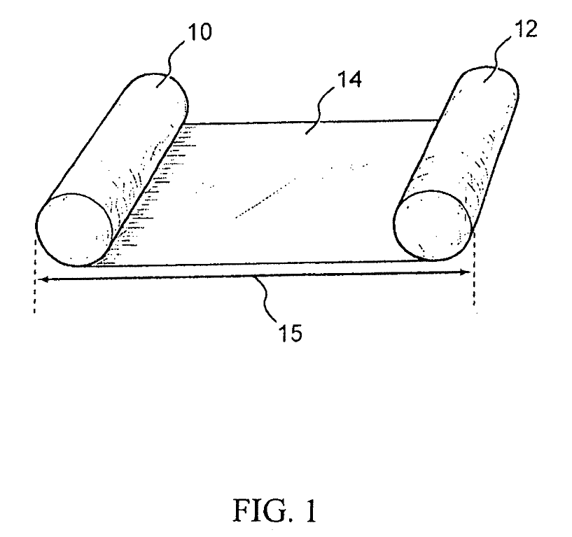

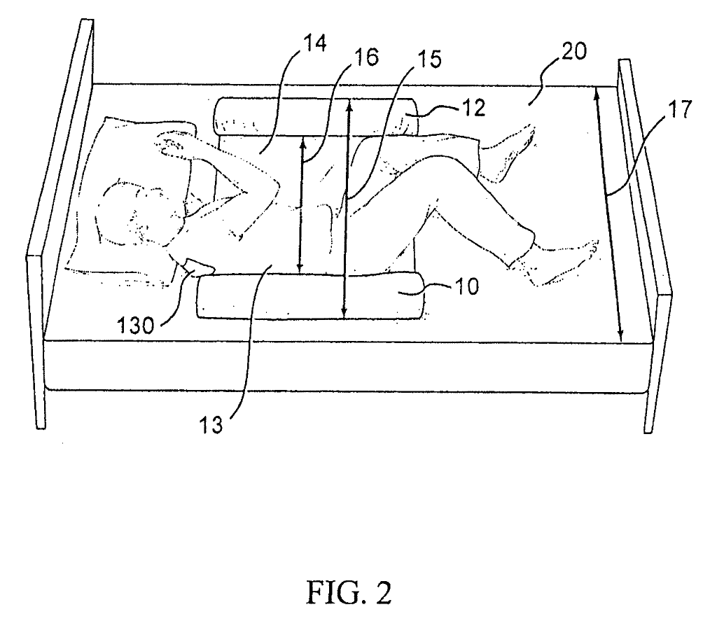

The dual pillow system shown in FIG. 1 illustrates a device that enables the body to be aware of the POSA. For example, in FIG. 2, the individual has one point of contact with the bed, lying on his left side. His back 13 is contacting a first pillow 10 and his knee is touching a second pillow 12. These opposing pillows are retained in position by the intermediate member 14, allowing the individual to move around while keeping various points of contact with the bed and two opposing pillows. The three points of contact provide the body with a frame of reference during these various movements.

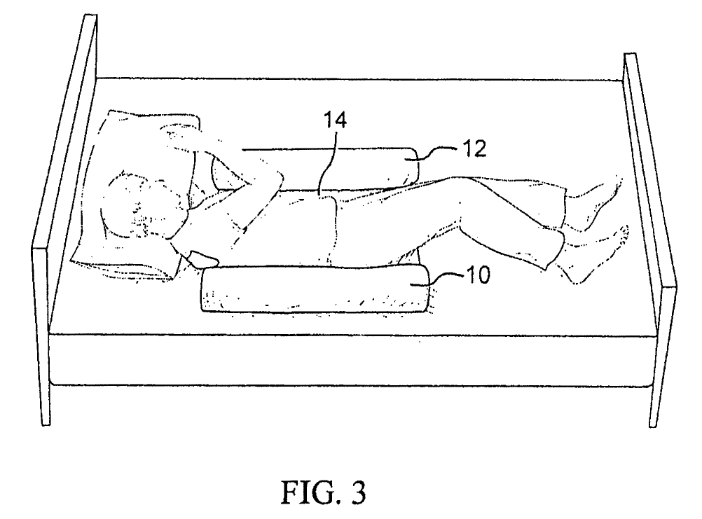

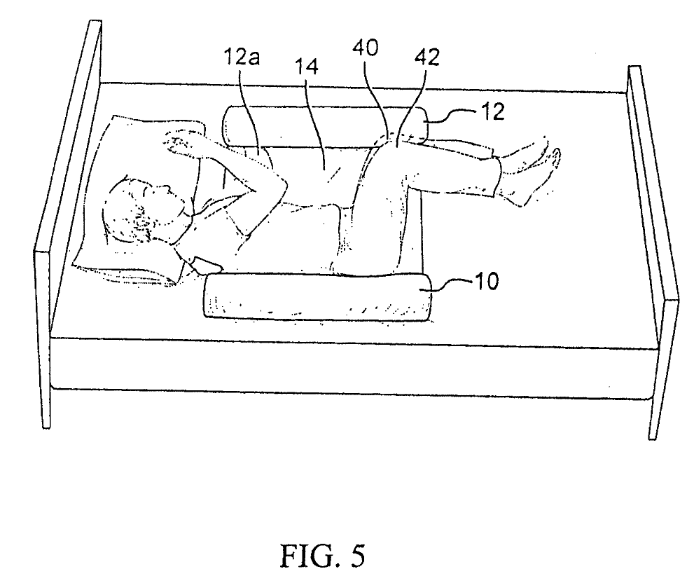

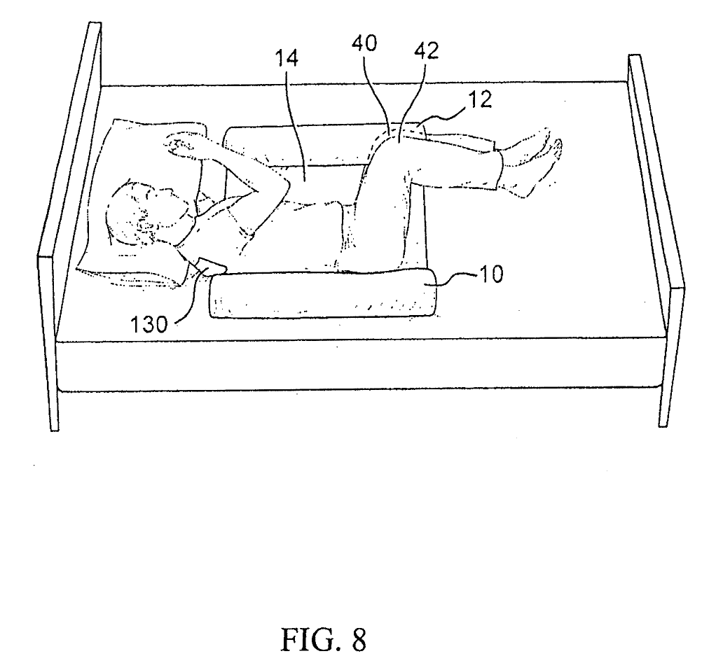

As discussed in the referenced patent application, FIGS. 3-8 illustrate some examples of alternate positions the body may assume, while maintaining the POSA condition. In using this device, the inventor has discovered a unique phenomenon that facilitates even greater awareness and ability for a user to condition or program his mind to assume favorable sleep positions as part of a side sleeping regimen. This concept is best understood by analogy to training the body to develop special skills and awareness of physical positioning through sports, dancing and music.

In expressing music, the position of the performer's body is uniquely controlled by a sequence of moves. A ballet dancer will assume a given position corresponding to each part of the music being performed. The dancer memorizes each physical movement in connection with specific parts of the music. The body is able to express very subtle movements in a fully predictable and reproducible manner, expressly timed with the music being performed. The dancer literally “feels” the music through movements of the body (legs, arms, torso, hands, feet—even eyes, mouth, finger tips, etc.). Similar practices are repeated by athletes in mastering their skills. These movements can be practiced over and over until they become subconscious expressions provided by the mind, as the dancer or athlete enjoys the experience with little thought of the details of movement.

Similarly, a pianist will manipulate his fingers, and even arms and body generally, as part of a memorized performance of a piece of music. In practicing the piece, the performer will initially focus on the position of the fingers with respect to the keys to learn the sequence of notes to be played in a given rhythm. To add expression, the individual will then vary and adjust the force applied, as well as add subtle expressions in which the body seemingly becomes one with the instrument in caressing, stroking, striking, and flowing with the musical line of the piece. The mind and body work together, with the performer feeling the various forms of contact, time and expression through interaction between the contacting fingers and the keyboard.

It is well known to musicians that all of this expression and movement can be reduced to how a note feels in the fingers, arms, and body as contact is made with the piano key. This simple key interface between the instrument and the performer becomes a method of remembering how to perform the piece the same way, over and over again. Once the performer has trained his mind to reproduce the exact touch and feel to any given note, he can reproduce this without even thinking of the details of the contact—he simply “feels” the note in the appropriate manner. He is NOT thinking of the myriad of complex muscular movements and pressures being implemented by the body, he only has to reproduce the feeling and everything follows.

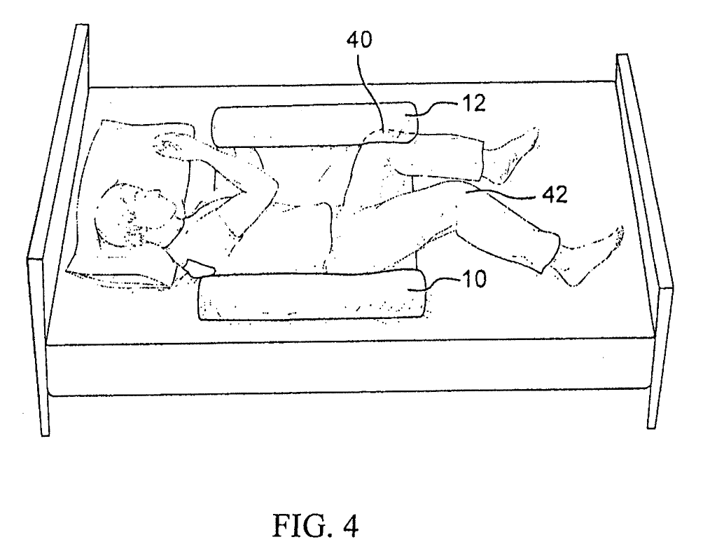

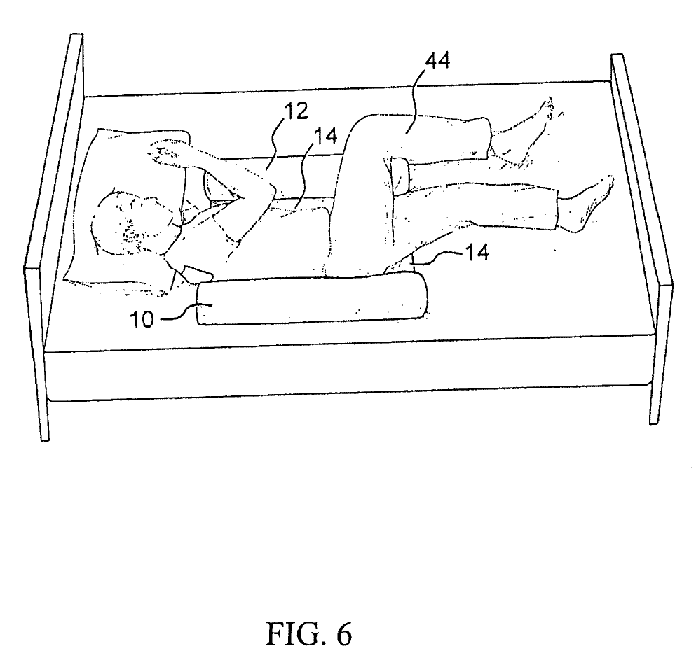

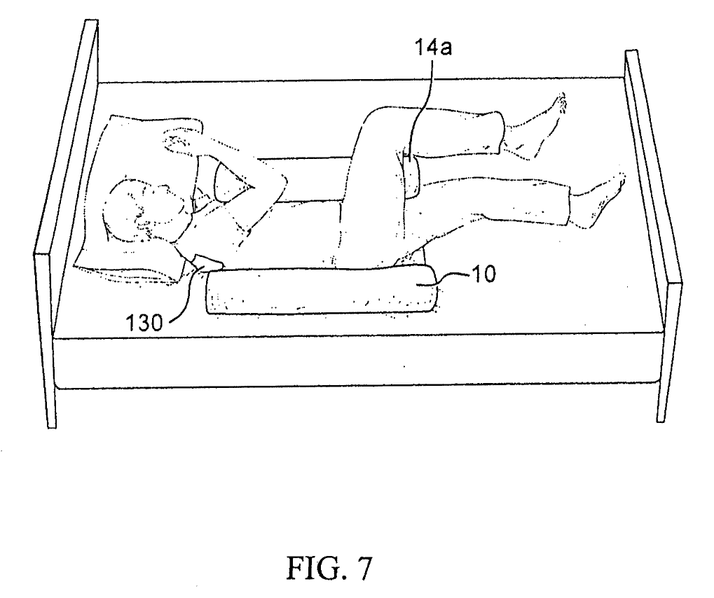

In a similar manner, the inventor has discovered that the dual pillow device of the present invention becomes an instrument of sleep. Specifically, the user will find that certain contact points with his body produce favorable positions of comfort as part of a side-sleeping regimen. For example, the relative position of the pillow with respect to the back, arms and legs as shown in the figures will be recorded in the user's memory. As some positions become recognizable preferences, the body will orient more repeatedly to those positions. Like a dancer, the individual can cycle through a sequence of positions that become somewhat of a ritual. In essence, the user develops a number, order, and arrangement of these positions that become favorites. These may include moving the contact portions of the legs from extended knees (FIGS. 4, 5 and 8) with various pillow positions, to supporting positions as illustrated in FIGS. 6 and 7. Other variations of pillow positioning with respect to the torso as shown in FIG. 3 can also be experienced.

Surprisingly, the body willingly responds to greater subtleties with variations in pressure between the legs and arms, with respect to the pressure applied at the user's back with pillow 10. As with the pianist that develops memory of many levels of pressure, duration, and body position through the contacting interface of his fingers with a piano key, so the sleeper can develop a memory of “feelings” with various contacts of his body with the two opposing pillows 10 and 12. This library of feelings may be developed into a variety of sleep regimens that become satisfying patterns of sleep position to the individual.

In time, these patterns can be reproduced subconsciously by the individual as a comfortable sequence of body movements that maintain the person in the desired side sleeping position. Because of the principle of POSA as enabled with the dual pillows, the user is capable of maintaining an awareness of his body position and thereby “performs” his sleep sequence in a comfortable and predictable manner. Over extended time and practice, the user can enjoy using the pillow system in a manner similar to the performer, dancer or athlete that has trained his body to experience a given sequence of contacts and feelings that provide a satisfying experience.

These concepts are generally represented by a method for reducing tendencies for occurrence of cardiovascular/pulmonary risk factors for a human body as part of a preventative health regimen comprising the steps of (a) positioning the body between opposing first and second pillows attached together by an intermediate member such that the body has concurrent opposing contact at forward and rearward orientations with respect to the two opposing pillows in tension, including contact of one pillow at a back portion of the body and contact of the second pillow with an extended arm or leg during natural sleep on a bed; (b) repeating a sequence of habitual side-sleeping positions of the body based on the forward and rearward contacts with the opposing pillows to establish a memory of the sequence and feelings associated with the contacts; and (c) applying this sequence during normal sleep to condition the body and mind to favor a side rather than supine sleeping orientation.

The method may further comprise the steps of applying positional orientation sleep aspect (POSA) in combination with at least one of the pillows placed at a users back to establish a three dimensional reference frame with respect to the side-sleeping position. An additional embodiment of the method comprises the step of increasing awareness of location on the leg of contact points with the second pillow and identifying at least one preferential contact point and reproducing this contact point as part of the memorizing step. In addition, the method may include the step of increasing awareness of location on the arm of contact points with the second pillow and identifying at least one preferential contact point and reproducing this contact point as part of the memorizing step. A further principle of the invention is the step of increasing awareness of contact pressure variations of contact points with the second pillow and identifying at least one preferential contact pressure level and reproducing this pressure at the contact point as part of the memorizing step.

FIGS. 3-8 illustrate one of many possible sequences of movement for an individual using the subject pillow system. Because each position and movement will be accompanied by many variations in contact pressure, as well as contact position with respect to the two pillows, the individual has a vast menu of possible experiences to satisfy the natural need for freedom of movement and expression during the night. There is virtually no limit to the user's ability to refine and improve his library of side-sleeping options.

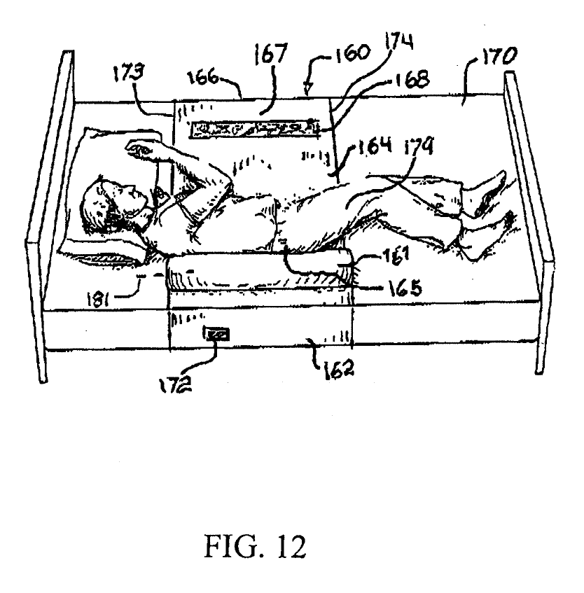

An additional variation of the parent patent application relates to sleeping with a companion. FIG. 12 illustrates a modified dual pillow system that allows for contact with a sleeping companion in place of one of the two pillows. It includes a pillow system 160 in which the intermediate support member 164 has an extended width configured to reach across the bed 170 toward an opposing side 166. One purpose of this extended width is to provide means for securing the intermediate support member to the bed surface on opposing sides of the bed. This limits migration of the pillow system across the bed surface as the user moves about in changing positions. It is also better suited for allowing a companion sleeper in the bed with the user. Indeed, the companion may provide one of the contact reference points for the user, in place of one of the pillows as previously identified.

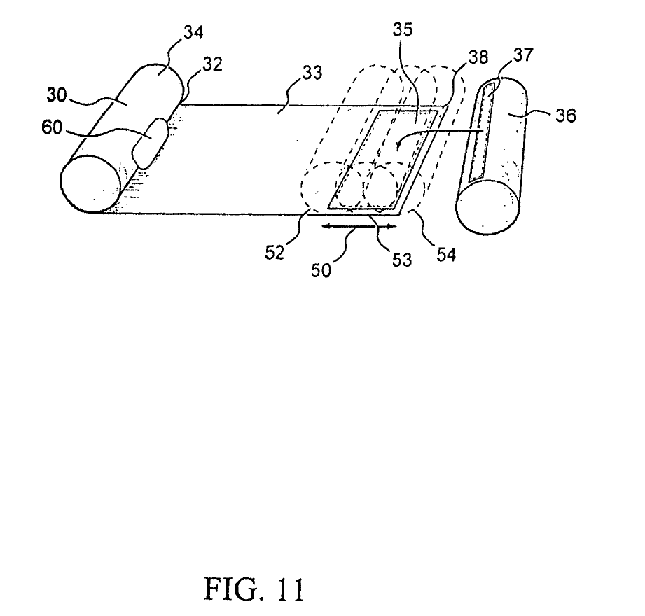

It will be apparent from the previous discussion that the presence of a pillow between the individual and a companion sleeper may be undesirable. For persons preferring closer proximity or contact with their companion, this embodiment permits one of the pillows to be temporarily set aside, for later retrieval if needed. For example, a second pillow 36, such as that shown in FIG. 11, can be attached to a Velcro® pad or otherwise suspended by attachment means 172 at the side of the mattress. If needed, this second pillow can then be retrieved by the user without getting out of bed, and can be applied to a compatible Velcro® attachment pad or other attachment means 168 on the support member 164 in a manner as described with respect to FIG. 11, items 35 and 36.

More specifically, the present POSA device and method can be adapted for developing a positional orientation sleep aspect (POSA) for an individual desiring its use with respect to a companion sleeper, to enhance the individual's awareness of sleeping position to enable the individual located on a bed 170 to assume at least one preselected side-sleeping orientation on either a left or right side. This device includes a support member 164 made of bed sheeting or other comfortable material configured for comfortable positioning under a lower trunk or low back portion 165 of the individual as part of a sleeping surface on the bed. The support member has upper 173 and lower 174 edges for orienting toward top and bottom portions of the bed, and opposing end portions 162 and 166 for positioning toward the opposing sides of the bed. The length of the support member as measured from top to bottom may be selected according to the height of the individual as previously discussed. It should be sufficient to at least extend from a position just above the low back 165 to at least a location in the mid-thigh region 179 of the individual's legs. This enables the user to pull the knees into various inclined positions for contacting a second pillow when attached, as previously disclosed. Although the drawings show the pillows and intermediate support member extending to the shoulders of the individual, such extension is not necessary. The most important contact position is at the low back region, so that the center of gravity of the individual is fully captured between the positions for the first and second pillows.

The first elongate pillow 161 is coupled to the support member 164 either permanently or removably by appropriate coupling structure. For example, it may be sewed directly as part of the support member, prefabricated as part of the system, or attached by snaps or Velcro, etc. If desired, the support member 164 can extend rearward, past the first pillow and be tucked under the mattress or otherwise fastened to the bed as show at item 162. An important design feature is that the support member be configured to be positioned at the bed surface with a longitudinal axis 181 of the pillow extending between the upper and lower edges of the support member to provide restraining support at a low back side of the individual with the individual in a side-sleeping position.

As mentioned, the support member also includes an extended portion 167 for laying across the bed away from the first pillow with sufficient length to provide a sleeping surface under a companion sleeper to be adjacent to the individual. In FIG. 12, this portion projects across the bed and drapes over the opposite side of the bed as shown at 166. This allows the support member to be tucked under the mattress to secure it in position so that it does not migrate as the companion sleeper may move about. Typically, the position of the companion will be located approximately where the attachment structure 168 is illustrated. The companion sleeper should be envisioned as occupying this space. Normally, the bed for use with two persons would be at least a double bed, rather than a single or twin size bed as shown in the drawings. Accordingly, it is to be understood that the companion sleeper is represented positionally by the attachment structure 168, which does not show a pillow as part of the system in FIG. 12. A design consideration, therefore, is that the opposing end portions of the support member should have sufficient separation length for securing at least one of the ends to the bed surface at a side of the bed most adjacent to the companion sleeper.

As has been previously discussed, the first pillow and support member are configured for positioning the individual's body in a preselected, side-position orientation on the support member to capture the support member under the lower trunk portion of the individual while establishing at least three separate and concurrent reference points of contact. In the present embodiment with a companion sleeper, these reference points include (i) at least one reference contact of the individual's trunk portion in the side-position orientation on the support member on the bed, and (ii) at least two reference points of contact at forward and back sides of the individual with and between the first pillow and the companion sleeper respectively. The companion sleeper therefore performs a function similar to one of the pillows of the earlier embodiments. Specifically, the pair of sleepers may lie next to each other with the front or back of the individual in contact with the pillow 161, and the companion sleeper providing the restraining support for the opposite side (trunk, legs or arms) of the individual. If the companion sleeper moves away from the individual and it becomes appropriate to apply the second pillow in that position, the individual simply reaches to the side of the bed (position 172) and retrieves the second pillow from its suspended location.

It is for this purpose that the support member has been configured to also service use of the second pillow as represented by item 36 in FIG. 11. Therefore, attachment structure 168 is positioned on the support member in parallel orientation with respect to the first pillow for attachment of the second pillow capable of providing resistive support to the individual. In this configuration, the first and second pillows define a pillow combination for providing the at least two reference points of contact at the forward and back sides of the individual independent of the companion sleeper. The second elongate pillow can then easily be coupled to the second pillow attachment structure 168 and configured to provide concurrent, juxtaposed support at forward and back sides of the individual disposed there between.

As preciously indicated, the first and second elongate pillows should have a separation distance approximately equal to a distance extending from the individual's low back side to a knee portion of the individual's leg extending at right angle to the individual's trunk. Other design features for this embodiment will be apparent to those skilled in the art based on the previous disclosed embodiments.

All of the various embodiments of the dual pillow system may be applied with respect to the concepts discussed above for development of preferred sleep positions as part of a side sleep regimen. It will be apparent to those skilled in the art, that this concept has general application to the public with respect to improving healthy sleep. By using the dual pillow, individuals can program their sleep activity toward healthy side-sleeping positions in a predictable manner. Since such sleeping positions are known to be anatomically favorable to healthy cardio/pulmonary function, the dual pillow can be viewed as a preventative tool for healthy sleep. As people are encouraged to shift toward the desired side-sleeping positions, an improvement in health should naturally follow.

Based on that disclosure, the invention may be publically implemented by numerous methods, including (i) general education procedures, (ii) commercial promotions encouraging use of products that may be useful to avoid a supine sleeping position, (iii) health insurance organization incentives such as premium discounts for side-sleepers and (iv) government policies that encourage an awareness of favorable health consequences to this all important component of lifestyle. Because we spend one third of our lives sleeping, the possibility exists that health can be enhanced with improved sleep without incurring any significant expense or discomfort. If young people were made aware and encouraged to form habits of appropriate sleep positioning in their early years, the conditioning of their minds and bodies would be a natural byproduct of their development and growth. Such simple action could reduce occurrence of cardiovascular and pulmonary health issues for the population generally and thereby reduce the ever increasing health costs. It is clear that conditioned side sleeping orientation would at least be favorable for the vast population currently suffering from snoring and sleep apnea. Accordingly, by adopting improved sleep positioning during years of health, future years of cardio and pulmonary health may be extended.

Specific examples of preventive application might include the following:
1. Family members having genetic predisposition to cardiovascular and pulmonary health issues can be encouraged to adopt the recommended side-sleeping regimen.
2. Persons having a family history of hypertension can be encouraged to adopt this regimen.
3. Individuals who have known high risk factors for OSA including obesity, diabetes mellitus, males and post-menopausal females or females with polycystic ovarian disease, and other other with anatomic risk factors such as retrognathia, mid-facial hypoplasia etc
4. Prevention of OSA alone will result in a major reduction in cost of health care since these individuals have been shown to have a great increase in expenditure when not treated.

It is to be understood that the above-referenced disclosure in combination with the embodiments provided in the accompanying patent application are only illustrative of the application for the principles of the present invention. Numerous modifications and alternative arrangements can be devised without departing from the spirit and scope of the present invention. While the present invention has been shown in the accompanying drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

I claim:

1. A method for reducing tendencies for occurrence of cardiovascular/pulmonary risk factors for a human body as part of a preventative health regimen comprising the steps of:
a. positioning the body between opposing first and second pillows attached together by an intermediate member such that the body has concurrent opposing contact at forward and rearward orientations with respect to the two opposing pillows in tension, including contact of one pillow at a back portion of the body and contact of the second pillow with an extended arm or leg during natural sleep on a bed;
b. repeating a sequence of habitual side-sleeping positions of the body based on the forward and rearward contacts with the opposing pillows to establish a memory of the sequence and feelings associated with the contacts; and
c. applying this sequence during normal sleep to condition the body and mind to favor a side rather than supine sleeping orientation.

2. A method as defined in claim 1, further comprising the steps of applying positional orientation sleep aspect (POSA) in combination with at least one of the pillows placed at a users back to establish a three dimensional reference frame with respect to the side-sleeping position.

3. A method as defined in claim 1, further comprising the step of increasing awareness of location on the leg of contact points with the second pillow and identifying at least one preferential contact point and reproducing this contact point as part of the memorizing step.

4. A method as defined in claim 1, further comprising the step of increasing awareness of location on the arm of contact points with the second pillow and identifying at least one preferential contact point and reproducing this contact point as part of the memorizing step.

5. A method as defined in claim 1, further comprising the step of increasing awareness of contact pressure variations of contact points with the second pillow and identifying at least one preferential contact pressure level and reproducing this pressure at the contact point as part of the memorizing step.

6. A method of promoting public awareness of the preventative health regimen for reducing tendencies of cardiovascular/pulmonary risk factors through developing a preferential side sleeping position by using a dual pillow system as part of a preventative health regimen comprising the steps of:
a. positioning the body between opposing first and second pillows attached together by an intermediate member such that the body has concurrent opposing contact at forward and rearward orientations with respect to the two opposing pillows in tension, including contact of one pillow at a back portion of the body and contact of the second pillow with an extended arm or leg during natural sleep on a bed;
b. repeating a sequence of habitual side-sleeping positions of the body based on the forward and rearward contacts with the opposing pillows to establish a memory of the sequence and feelings associated with the contacts; and
c. applying this sequence during normal sleep to condition the body and mind to favor a side rather than supine sleeping orientation.

7. A method as defined in claim 6, further comprising the step of increasing application of the preventative health regimen for reducing tendencies of cardiovascular/pulmonary risk factors through offering health insurance premium discounts for developing the preferential side sleeping position prior to diagnosis of sleep apnea.

8. A method as defined in claim 6, further comprising the step of advertising sleep products in combination with preventative benefits of side sleeping.

9. A method as defined in claim 6, further comprising the step of prescribing side sleep therapy as part of treatment for hypertension in a preventative posture with respect to future conditions of sleep apnea.

10. A device for developing a positional orientation sleep aspect (POSA) for an individual with respect to a companion sleeper, to enhance the individual's awareness of sleeping position to enable the individual located on a bed to assume at least one preselected side-sleeping orientation on either a left or right side, said device comprising:
a) a support member configured for comfortable positioning under a lower trunk portion of the individual as part of a sleeping surface on the bed and between opposing sides of the bed in a perpendicular orientation to the individual, said support member having upper and lower edges for orienting toward top and bottom portions of the bed, and opposing end portions for positioning toward the opposing sides of the bed; and
b) a first elongate pillow coupled and secured to the support member and configured to be positioned at the bed surface with a longitudinal axis of the pillow extending between the upper and lower edges of the support member to provide restraining support at a low back side of the individual with the individual in a side-sleeping position;
c) a second elongate pillow removably attached to the support member in a location approximately where the companion sleep would lie adjacent to the individual;
d) the support member having an extended portion for laying across the bed away from the first pillow with sufficient length to provide a sleeping surface under both the individual and a companion sleeper to be adjacent to the individual;
e) the first pillow and support member being configured for positioning the individual's body in a preselected, side-position orientation on the support member to capture the support member under the lower trunk portion of the individual while establishing at least three separate and concurrent reference points of contact with the individual, including (i) at least one reference contact of the individual's trunk portion in the side-position orientation on the support member on the bed, and (ii) at least two reference points of contact at forward and back sides of the individual with and between the first pillow and the second pillow or companion sleeper respectively.

11. A device as defined in claim 10, said support member further including second pillow attachment structure positioned in parallel orientation with respect to the first pillow for attachment of the second pillow capable of providing resistive support to the individual, said first and second pillows defining a pillow combination for providing the at least two reference points of contact at the forward and back sides of the individual independent of the companion sleeper.

12. A device as defined in claim 10, further comprising a second elongate pillow removably coupled to the second pillow attachment structure and configured to provide concurrent, juxtaposed support at forward and back sides of the individual disposed there between; said first and second elongate pillows having a separation distance approximately equal to a distance extending from the individual's low back side to a knee portion of the individual's leg extending at right angle to the individual's trunk.

13. A device as defined in claim 11, wherein the second pillow includes attachment structure positioned longitudinally along one side of the pillow corresponding to the second pillow attachment structure of the support member.

14. A device as defined in claim 10, wherein the opposing end portions of the support member have sufficient separation length for securing at least one of the ends of the support member to the bed surface at a side of the bed most adjacent to the companion sleeper.

15. A device as defined in claim 14, further comprising attachment structure at the opposing ends of the support structure for securing both of the ends of the support member to the bed to stabilize the support member in a desired position with respect to the individual and companion sleeper.
